(19) United States
(12) Patent Application Publication
(10) Pub. No.: US 2011/0152120 A1
(43) Pub. Date: Jun. 23, 2011

(54) METHOD OF CHARACTERIZING ANTIBODIES

(75) Inventors: Karl Andersson, Upsala (SE); Robert Karlsson, Uppsala (SE)

(73) Assignee: GE HEALTHCARE BIO-SCIENCES AB, UPPSALA (SE)

(21) Appl. No.: 13/059,753

(22) PCT Filed: Aug. 17, 2009
(86) PCT No.: PCT/SE2009/050936

§ 371 Date: Feb. 18, 2011

(30) Foreign Application Priority Data
Aug. 22, 2008 (SE) 0801824-4

(51) Int. Cl. C40B 30/04

(52) U.S. Cl. 506/9

(57) ABSTRACT

A method of characterizing a population of antibodies to an antigen comprises contacting a sensor surface having the antigen immobilized thereto with a sample containing the antibody population to bind antibodies to the surface, and detecting dissociation of antibodies from the sensor surface during a dissociation phase when sample no longer contacts the surface. Based on the dissociation behaviour, the antibody population is characterized in terms of subpopulations of more and less stable antibodies, respectively. The method may be used to determine the immunogenicity of drug by monitoring the appearance of anti-drug antibodies in a patient over time, and determining any shift in proportions between more stable and less stable antibodies.

### CROSS-REFERENCE TO RELATED APPLICATIONS

This application is a filing under 35 U.S.C. §371 and claims priority to international patent application number PCT/SE2009/050936 filed Aug. 17, 2009, published on Feb. 25, 2010 as WO 2010/021586, which claims priority to application number 0801824-4 filed in Sweden on Aug. 22, 2008.

### FIELD OF THE INVENTION

The present invention relates to a method of characterizing antibodies, and more particularly characterizing a heterogeneous antibody population obtained in an immune response to a therapeutic drug or a vaccine.

### BACKGROUND OF THE INVENTION

Immunogenicity is the ability to, or the degree to which a particular substance may provoke an immune response, such as the production of specific antibodies. The immune reaction may be desirable, as in the natural reaction of the immune defense system to infection, or in the provoked reaction to vaccines. The immune reaction may, however, also be unwanted, as when induced antibodies counteract the effect of administered drugs.

In recent years, immunogenicity has gained increasing focus in the context of immune reaction to biotherapeutics, often referred to as “biologics”. Biotherapeutics or biologics are large-molecule drugs or medicines based on proteins, peptides and antibodies that primarily come from molecular biology developments. Usually, the terms also includes vaccines.

As more biomolecules, such as natural or engineered inhibitors, effectors or antibodies are used as therapeutics, issues related to the immunogenicity of the molecules become more important.

Both the occurrence and the effects of an immune response to biologics vary widely. Administration of a biotherapeutic drug does not always elicit an immune response in the patient, and the same drug may cause a response in some patients but not in others. On the other hand, many drugs elicit an immune response without affecting the efficacy of the treatment, so that the detected production of antibodies does not necessarily indicate that the immune response will be clinically relevant.

Undesired effects of the immune response to biologics include reduced or complete neutralization of the effect of the desired effect of therapy, formation of antibody-drug complexes which may effect the pharmacokinetic properties of the agent, as well as undesirable side-effects, which sometimes may be analogous to auto-immune conditions.

For a biotherapeutic drug, the goal is usually to avoid or minimize the immune response, at least in terms of clinically relevant antibodies, and characterization of the immunogenic properties of the drug is therefore a critical issue in the drug development.

Development of vaccines also rely on characterization of immunogenicity, but from a different perspective than biotherapeutic development. Vaccines are designed to elicit a long-lived immune defense reaction against the pathogen, and low levels of antibody production are therefore generally uninteresting. Any clinical side-effects of the antibody need to be studied, but the primary characteristic of the antibody is that it should neutralize the effect of the pathogen.

Antibodies elicited in response to a vaccine or a biotherapeutic, such as a protein drug, represent a broad spectrum of classes and affinities. The antibody response to an immunogen generally also changes over time in a single individual, as the mixture of antibody classes and affinities changes. Physical and clinical effects of the immune response may change as the antibody population changes. Immunogenicity in the context of biotherapeutic treatments is thus a complex issue where the behaviour and effects of the immune response may vary both from case to case and over time.

Analytical sensor systems that can monitor molecular interactions in real time are gaining increasing interest. These systems are often based on optical biosensors and usually referred to as interaction analysis sensors or biospecific interaction analysis sensors. A representative such biosensor system is the BIACORE® instrumentation sold by GE Healthcare (Uppsala, Sweden) which uses surface plasmon resonance (SPR) for detecting interactions between molecules in a sample and molecular structures immobilized on a sensor surface. With the BIACORE® systems it is possible to determine in real time without the use of labeling not only the presence and concentration of a particular molecule in a sample, but also additional interaction parameters such as, for instance, the association rate and dissociation rate constants for the molecular interaction.

By immobilizing a therapeutic drug to the sensing surface and measuring the response when the surface is contacted with antibody-containing samples, the presence of antibodies specific for the drugs can be screened. The response level obtained reflects the amount of antibody in the sample. By utilizing an acidification/neutralization procedure as disclosed in WO 08/033,073 A1, also antibodies complexed with drug in the samples can be detected.

Since, as mentioned above, the antibody population obtained in response to a vaccine or a biotherapeutic, may represent a broad spectrum of affinities and classes, the binding and dissociation of antibody from the sensor surface is complex. It is readily seen that characterizing such an antibody population is a tedious and laborious task. There is therefore a need for sensor-based methods which permit easy characterization and comparison of immune response-derived antibody populations.

### SUMMARY OF THE INVENTION

The above and other objects and advantages are provided by a method which characterizes the antibodies in terms of the stability of binding to a drug immobilized to a sensor surface, and more particularly by assessing the immune complex stability by studying the dissociation of bound antibodies and classifying the antibody population in terms of predominance of rapidly or slowly dissociating antibodies.

In one aspect, the present invention provides a method of characterizing a population of antibodies to an antigen, which comprises providing a sensor surface having the antigen immobilized thereto, contacting the sensor surface with a sample containing the antibody population to bind antibodies to the surface, studying dissociation of antibodies from the sensor surface during a dissociation phase when sample no longer contacts the surface, wherein the dissociation behaviour of the antibody population is characterized by analyzing a first subpopulation and a second subpopulation of said antibody population, and wherein antibodies in said first subpopulation form a more stable complex with the immobilized antigen than antibodies in said second subpopulation.

The antigen may be a therapeutic drug, preferably a biotherapeutic, or a vaccine.

In a preferred embodiment, the sample is contacted with separate sensor surfaces or sensor surface areas supporting different domains of the antigen immobilized thereto.

In another preferred embodiment, the sample is contacted with sensor surfaces or sensor surface areas with different densities of immobilized antigen or antigen domains.

In another aspect, the present invention provides a method of determining the immunogenicity of drug, which comprises monitoring the appearance of anti-drug antibodies in a patient over time by the method of the first-mentioned aspect, and determining any shift in proportions between more stable and less stable antibodies.

A more complete understanding of the present invention, as well as further features and advantages thereof, will be obtained by reference to the following detailed description and drawings.

### BRIEF DESCRIPTION OF THE DRAWINGS

FIG. 1 is a schematic side view of a biosensor system based on SPR.

FIG. 2 is a representative sensorgram showing detector response versus time for the interaction between an analyte and an immobilized binder for the analyte.

### DETAILED DESCRIPTION OF THE INVENTION

Unless defined otherwise, all technical and scientific terms used herein have the same meaning as commonly understood by a person skilled in the art related to this invention. Also, the singular forms “a”, “an”, and “the” are meant to include plural reference unless it is stated otherwise.

All publications, patent applications, patents, and other references mentioned herein are incorporated by reference in their entirety.

As mentioned above, the invention relates to the characterization of antibody populations produced in response to an immune reaction provoked by an immunogen. In brief, the antibody population is characterized in terms of the stability of the antibody-antigen complex formed when a sample containing a heterogeneous antibody population is contacted with a sensor surface with immobilized antigen. More particularly, the stability of the antibody-antigen complex is determined by studying the dissociation behaviour of bound antibodies at the sensor surface.

The antibody population may represent a broad spectrum of affinities within and between different antibody classes, and the dissociation behaviour of antibody from the sensor surface is correspondingly complex. Attempting to describe the dissociation behaviour of such a population in terms of a single interaction does not give satisfactory results, partly because of the heterogenicity of the antibody population, and partly because antibodies are normally bi- or multivalent. Also, it is not practicable to resolve the behaviour into components that represent individual antibody species.

According to the invention, as a compromise, the dissociation behaviour is considered to be composed of the averaged behaviours of two antibody subpopulations, one forming a less stable complex with antigen (showing rapid dissociation behaviour) and one subpopulation forming a more stable complex with antigen (showing a slower dissociation behaviour). Notably, while this does not imply that there are two distinct populations of antibodies in the sample, this approach is an empirical compromise that describes the behaviour satisfactorily and helps to classify the immune response in terms of predominance of rapidly or slowly dissociating antibody subpopulations. The antibody population may then conveniently be characterized in terms of the subpopulations or fractions of rapidly and slowly, respectively, dissociating antibodies.

Before describing the present invention in more detail, however, the general context in which the invention is intended to be used will be described.

The sensor used in the present invention is typically a biosensor. Biosensors are usually based on label-free techniques, detecting a change in a property of a sensor surface, such as e.g. mass, refractive index, or thickness for the immobilised layer, but there are also sensors relying on some kind of labelling. Typical sensor detection techniques include, but are not limited to, mass detection methods, such as optical, thermo-optical and piezoelectric or acoustic wave methods (including e.g. surface acoustic wave (SAW) and quartz crystal microbalance (QCM) methods), and electrochemical methods, such as potentiometric, conductometric, amperometric and capacitance/impedance methods. With regard to optical detection methods, representative methods include those that detect mass surface concentration, such as reflection-optical methods, including both external and internal reflection methods, which are angle, wavelength, polarization, or phase resolved, for example evanescent wave ellipsometry and evanescent wave spectroscopy (EWS, or Internal Reflection Spectroscopy), both of which may include evanescent field enhancement via surface plasmon resonance (SPR), Brewster angle refractometry, critical angle refractometry, frustrated total reflection (FTR), scattered total internal reflection (STIR) (which may include scatter enhancing labels), optical wave guide sensors; external reflection imaging, evanescent wave-based imaging such as critical angle resolved imaging, Brewster angle resolved imaging, SPR-angle resolved imaging, and the like. Further, photometric and imaging/microscopy methods, “per se” or combined with reflection methods, based on for example surface enhanced Raman spectroscopy (SERS), surface enhanced resonance Raman spectroscopy (SERRS), evanescent wave fluorescence (TIRF) and phosphorescence may be mentioned, as well as waveguide interferometers, waveguide leaky mode spectroscopy, reflective interference spectroscopy (RIfS), transmission interferometry, holographic spectroscopy, and atomic force microscopy (AFR).

Commercially available biosensors include the afore-mentioned BIACORE® systems, manufactured and marketed by GE Healthcare, Uppsala, Sweden, and the PROTEON™ XPR36 system, manufactured and marketed by Bio-Rad Laboratories Inc., CA, USA), which are both based on surface plasmon resonance (SPR) and permit monitoring of surface binding interactions in real time between a bound ligand and an analyte of interest. In this context, “ligand” is a molecule that has a known or unknown affinity for a given analyte and includes any capturing or catching agent immobilized on the surface, whereas “analyte” includes any specific binding partner thereto.

While in the detailed description and Examples that follow, the present invention is illustrated in the context of SPR spectroscopy, and more particularly the BIACORE® systems, it is to be understood that the present invention is not limited to this detection method. Rather, any affinity-based detection method where an analyte binds to a ligand immobilised on a sensing surface may be employed, provided that a change at the sensing surface can be measured which is quantitatively indicative of binding of the analyte to the immobilised ligand thereon.

The phenomenon of SPR is well known, suffice it to say that SPR arises when light is reflected under certain conditions at the interface between two media of different refractive indices, and the interface is coated by a metal film, typically silver or gold. In the BIACORE® instruments, the media are the sample and the glass of a sensor chip which is contacted with the sample by a microfluidic flow system. The metal film is a thin layer of gold on the chip surface. SPR causes a reduction in the intensity of the reflected light at a specific angle of reflection. This angle of minimum reflected light intensity—the resonance angle—varies with the refractive index close to the surface on the side opposite from the reflected light, in the BIACORE® system the sample side. A change of refractive index close to the surface, resulting from e.g. molecular binding thereto, causes a shift in resonance angle and this shift is measured as a response signal.

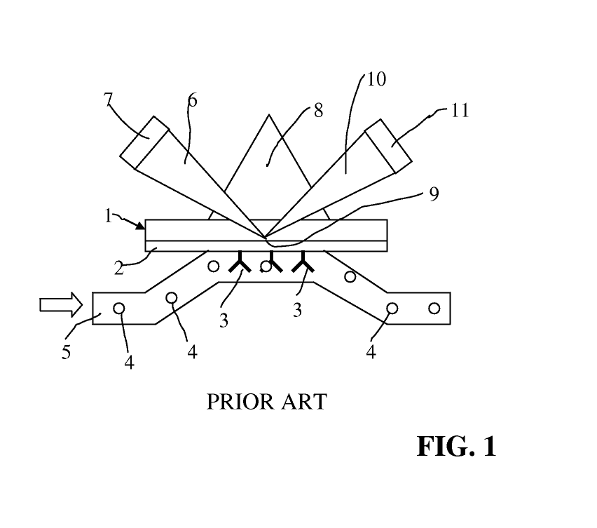

A schematic illustration of the BIACORE® system is shown in FIG. 1. Sensor chip 1 has a gold film 2 supporting capturing molecules (ligands) 3, e.g. antibodies, exposed to a sample flow with analytes 4, e.g. an antigen, through a flow channel 5. Monochromatic p-polarised light 6 from a light source 7 (LED) is coupled by a prism 8 to the glass/metal interface 9 where the light is totally reflected. The intensity of the reflected light beam 10 is detected by an optical detection unit 11 (photodetector array).

A detailed discussion of the technical aspects of the BIACORE® instruments and the phenomenon of SPR may be found in U.S. Pat. No. 5,313,264. More detailed information on matrix coatings for biosensor sensing surfaces is given in, for example, U.S. Pat. Nos. 5,242,828 and 5,436,161. In addition, a detailed discussion of the technical aspects of the biosensor chips used in connection with the BIACORE® instruments may be found in U.S. Pat. No. 5,492,840.

When molecules in the sample bind to the capturing molecules on the sensor chip surface, the concentration, and therefore the refractive index at the surface changes and an SPR response is detected. Plotting the response against time during the course of an interaction will provide a quantitative measure of the progress of the interaction. Such a plot, or kinetic or binding curve (binding isotherm), is usually called a sensorgram, also sometimes referred to in the art as “affinity trace” or “affinogram”. In the BIACORE® systems, the SPR response values are expressed in resonance units (RU). One RU represents a change of 0.0001° in the angle of minimum reflected light intensity, which for most proteins and other biomolecules correspond to a change in concentration of about 1 pg/mm² on the sensor surface. As sample containing an analyte contacts the sensor surface, the capturing molecule (ligand) bound to the sensor surface interacts with the analyte in a step referred to as “association.” This step is indicated on the sensorgram by an increase in RU as the sample is initially brought into contact with the sensor surface. Conversely, “dissociation” normally occurs when the sample flow is replaced by, for example, a buffer flow. This step is indicated on the sensorgram by a drop in RU over time as analyte dissociates from the surface-bound ligand.

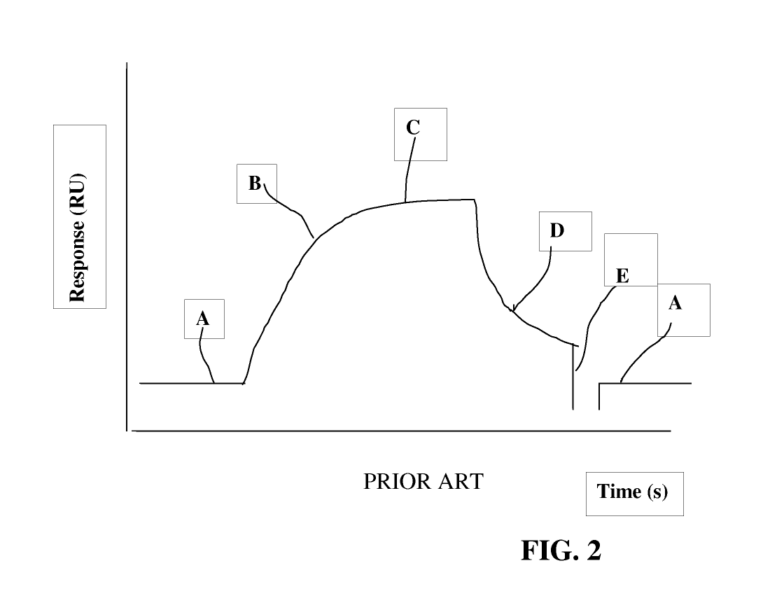

A representative sensorgram (binding curve) for a reversible interaction at the sensor chip surface is presented in FIG. 2, the sensing surface having an immobilised capturing molecule, or ligand, for example an antibody, interacting with a binding partner therefor, or analyte, in a sample. The binding curves produced by biosensor systems based on other detection principles mentioned above will have a similar appearance. The vertical axis (y-axis) indicates the response (here in resonance units, RU) and the horizontal axis (x-axis) indicates the time (here in seconds). Initially, buffer is passed over the sensing surface giving the baseline response A in the sensorgram. During sample injection, an increase in signal is observed due to binding of the analyte. This part B of the binding curve is usually referred to as the “association phase”. Eventually, a steady state or equilibrium condition is reached at or near the end of the association phase where the resonance signal plateaus at C (this state may, however, not always be achieved). At the end of sample injection, the sample is replaced with a continuous flow of buffer and a decrease in signal reflects the dissociation, or release, of analyte from the surface. This part D of the binding curve is usually referred to as the “dissociation phase”. The analysis is ended by a regeneration step where a solution capable of removing bound analyte from the surface, while (ideally) maintaining the activity of the ligand, is injected over the sensor surface. This is indicated in part E of the sensorgram. Injection of buffer restores the baseline A and the surface is now ready for a new analysis.

From the profiles of the association and dissociation phases B and D, respectively, information regarding the binding and dissociation kinetics is obtained, and the height of the resonance signal at C represents affinity (the response resulting from an interaction being related to the change in mass concentration on the surface).

The rate of dissociation in the dissociation phase can be expressed as:

$$\frac{d R}{d t} = - {k}_{d} R$$

and in integrated form:

R=R₀·e^{-k}^{_{d}}^{t}

where R is the response at time t in resonance units (RU), R₀ is the response at the beginning of the dissociation phase (when the buffer wash of the surface starts), and k_{d} is the dissociation rate constant.

And now back to the present invention. As mentioned the dissociation behaviour is considered to be composed of the averaged behaviours of two antibody subpopulations originating from one and the same antibody population, one with more rapid dissociation and one with slower dissociation. To this end, dissociation kinetics are typically determined by fitting the dissociation phase of the sensorgrams to an equation which describes simultaneous dissociation from two independent monovalent sites on the antigen:

R=R₁*e^{-k}^{_{d1}}^{(t-t}^{₀}⁾+R₂*e^{-k}^{_{d2}}^{(t-t}^{₀}⁾

where R is the detection response time at time t, R₁ and R₂ are the response contributions from the two sites at the beginning of the dissociation at time t₀, and k_{d1} and k_{d2} are the dissociation rate constants for the two sites.

It is to be noted that this equation is based on simple monovalent dissociation kinetics at the two sites. Antibodies are usually bi- or multivalent, which complicates the dissociation behaviour further. However, while the two-site monovalent model provides a sufficiently good empirical description of the observed dissociation in most cases, it should be realized that the dissociation characteristics reported by the evaluation are empirical and do not represent formal kinetic parameters.

For presentation and evaluation of the results, the apparent dissociation rate constants determined by the fitting procedure are usually converted to half-lives, t_{1/2}, i.e. the time required for the amount of complex to be reduced by 50%:

$${t}_{\frac{1}{2}} = \frac{ln 2}{{k}_{d}} .$$

If the dissociation behaviour describes a true exponential curve and can therefore in principle be analyzed with a single site model, the two-site fitting procedure will typically return either one population with a very low fraction and a non-significant value for t_{1/2} or two populations with closely similar values for t_{1/2} and an unpredictable division of the response between the populations. Also, if either one fraction is calculated as less than, say, 1% or the values for t_{1/2} in the two populations differ by less than, say, 10%, the evaluation will typically assign the whole antibody population to the slow fraction and report the fast fraction as 0%.

Conveniently, the results from the fitting are described by four parameters.
Fraction fast
tt_{1/2} fast
Fraction slow
t_{1/2} slow
   It is to be noted that the terms fast (rapid) and slow do not refer to any absolute values for t_{1/2}, but are applied individually to the fitted results for each separate sample.

With the above-mentioned BIACORE® system, for example, the dissociation data selected for the fitting should be selected shortly after the end of the sample contact with the sensor surface to minimize interference from bulk refractive index contributions in the sample which may otherwise be interpreted as rapid dissociation events and contribute to the reported fast population of antibodies.

As mentioned above, antibodies elicited in response to a vaccine or to a biotherapeutic usually represent broad spectrum of classes and affinities. Not only may the antibodies have different kinetic properties, but they may also compete for the same epitope and/or there may be avidity effects.

Preferably, the sample is therefore contacted with sensor surfaces or surface areas having different antigen domains (rather than or in addition to intact antigen) immobilized thereto. By subdividing the antigen into parts in this way, it will thus be possible to detect site specific antibodies. The different antigen parts, which may be produced by recombinant DNA technology as is well known in the art, may be immobilized on separate sensor surfaces or on separate areas or spots of a linear or two-dimensional array type sensor surface.

To be able to compensate for avidity effects that may influence the apparent affinities of the antibodies, the sample is preferably contacted with sensor surfaces or surface areas varying densities of the immobilized antigen or antigens.

The above-mentioned four parameters fraction fast, t_{1/2} fast, fraction slow and t_{1/2} slow are the pattern obtained from the different surfaces or surface areas are then used to describe and rank the total polyclonal antibody response.

In case of therapeutic drugs, since an immune response may cause side effects or neutralize the drug, it is of interest to monitor individual patients to determine any shift over time in apparent stability of antibody binding and any shift in the proportions between more stable and less stable antibodies.

Also, in the case of therapeutic drugs, the present antibody characterization method may be used to group responders and find parameters that can be used to predict relevance of different response patterns for a successful therapy.

In vaccine testing, the antibody characterization method may be used to test that antibodies are expressed as expected and the patterns obtained can be indicative of whether a useful immune response has been obtained or not.

In the following Examples, various aspects of the present invention are disclosed more specifically for purposes of illustration and not limitation.

### EXAMPLES

The present examples are provided for illustrative purposes only, and should not be construed as limiting the scope of the present invention as defined by the appended claims. All references given below and elsewhere in the present specification are hereby included herein by reference.

### Instrumentation

A BIACORE® T100 (GE Healthcare, Uppsala, Sweden) was used. This instrument, which is based on surface plasmon resonance (SPR) detection at a gold surface on a sensor chip, uses a micro-fluidic system (integrated micro-fluidic cartridge—IFC) for passing samples and running buffer through four individually detected flow cells, designated Fc 1 to Fc 4, one by one or in series. The IFC is pressed into contact with the sensor chip by a docking mechanism within the BIACORE® T100 instrument.

As sensor chip was used Series CM5 (GE Healthcare, Uppsala, Sweden) which has a gold-coated (about 50 nm) surface with a covalently linked hydrogel matrix (about 100 nm) of carboxymethyl-modified dextran polymer.

The output from the instrument is a “sensorgram” which is a plot of detector response (measured in “resonance units”, RU) as a function of time. An increase of 1000 RU corresponds to an increase of mass on the sensor surface of approximately 1 ng/mm²

### Example 1

### Binding Stability Analysis on Surface with Low Ligand Density

A model system consisting of beta-2-microglobulin as ligand and a polyclonal anti-beta-2-microglobulin antibody as analyte was used. Beta-2-microglobulin was immobilized on sensor chip CM5 using Amine Coupling Kit (GE Healthcare, Uppsala, Sweden) according to the manufacturer's instructions. The immobilization was performed in the presence of ethanolamine to obtain a sufficiently low ligand density.

The analysis was performed in the BIACORE® T100 instrument including “Immunogenicity Package” software.

Five different concentrations of the polyclonal antibody diluted in HBS-EP+ were used: 5, 10, 25, 50 and 100 μg/ml. Two different injection times were tested, 60 and 90 seconds, respectively, while the dissociation time was held constant to 600 seconds. The analysis was performed with the instrument's “Method Builder” support and comprised four assay steps.

Assay Step1 5-100 μg/ml, injection for 60 s
Assay Step 2 5-100 μg/ml, injection for 90 s
Assay Step 3 5-100 μg/ml, injection for 60 s
Assay Step 4 5-100 μg/ml, injection for 90 s

Four Start Up cycles were run before analysis and between each Assay Step a control sample with buffer was run. Only flow cells Fc3 and Fc4 were used in the analysis. Immobilization in Fc4 and Fc3 were used as reference. The flow rate was 30 μl/min.

The analysis was evaluated in BIACORE® T100 Evaluation Software 2.0. The obtained values that were evaluated are Fast Fraction (%), t_{1/2} Fast (s), t_{1/2} Slow (s) and Chi². The results are presented in Table 1 below.

TABLE 1

| | | Inject. | Fast | | | | RelResp | RelResp | RelResp | |
|---|---|---|---|---|---|---|---|---|---|---|
| | Conc | Time | Fraction | Slow | t½ Fast | t½ Slow | Tot | Fast | Slow | Chi² |
| Cycle# | (μg/ml) | (s) | (%) | Fraction (%) | (s) | (s) | (RU) | (RU) | (RU) | (RU²) |
| 6 | 5 | 60 | 60 | 40 | 42 | 5.00E+02 | 1.3 | 0.8 | 0.5 | 0.003 |
| 7 | 10 | 60 | 26 | 74 | 59 | 2.60E+03 | 2.9 | 0.7 | 2.1 | 0.0028 |
| 8 | 25 | 60 | 24 | 76 | 87 | 4.60E+03 | 6.1 | 1.5 | 4.7 | 0.0031 |
| 9 | 50 | 60 | 19 | 81 | 72 | 3.10E+03 | 9.6 | 1.8 | 7.8 | 0.0031 |
| 10 | 100 | 60 | 18 | 82 | 80 | 3.10E+03 | 13.9 | 2.5 | 11.4 | 0.0035 |
| 12 | 5 | 90 | 52 | 48 | 94 | 5.80E+03 | 1.7 | 0.9 | 0.8 | 0.0029 |
| 13 | 10 | 90 | 20 | 80 | 54 | 2.80E+03 | 3.9 | 0.8 | 3.1 | 0.0034 |
| 14 | 25 | 90 | 19 | 81 | 83 | 3.90E+03 | 7.7 | 1.5 | 6.2 | 0.0028 |
| 15 | 50 | 90 | 16 | 84 | 76 | 3.00E+03 | 11.6 | 1.8 | 9.7 | 0.0031 |
| 16 | 100 | 90 | 15 | 85 | 70 | 2.70E+03 | 16.1 | 2.4 | 13.8 | 0.0034 |
| 18 | 5 | 60 | 55 | 45 | 41 | 5.00E+02 | 1.3 | 0.7 | 0.6 | 0.0027 |
| 19 | 10 | 60 | 25 | 75 | 62 | 2.80E+03 | 2.9 | 0.7 | 2.1 | 0.0035 |
| 20 | 25 | 60 | 21 | 79 | 68 | 3.60E+03 | 6 | 1.2 | 4.7 | 0.003 |
| 21 | 50 | 60 | 17 | 83 | 72 | 2.90E+03 | 9.3 | 1.6 | 7.7 | 0.0029 |
| 22 | 100 | 60 | 17 | 83 | 60 | 2.50E+03 | 13.9 | 2.3 | 11.6 | 0.0033 |
| 24 | 5 | 90 | 46 | 54 | 67 | 2.70E+03 | 1.6 | 0.8 | 0.9 | 0.0032 |
| 25 | 10 | 90 | 18 | 82 | 55 | 2.40E+03 | 3.8 | 0.7 | 3.1 | 0.0027 |
| 26 | 25 | 90 | 15 | 85 | 48 | 2.40E+03 | 7.7 | 1.1 | 6.6 | 0.0028 |
| 27 | 50 | 90 | 16 | 84 | 79 | 3.10E+03 | 11.4 | 1.8 | 9.6 | 0.003 |
| 28 | 100 | 90 | 15 | 85 | 76 | 2.90E+03 | 16 | 2.4 | 13.6 | 0.0029 |

As appears from Table 1, it is mainly the lowest concentration, 5 μg/ml, that causes to the dispersion of the obtained values, which, however, be due to the low detector response obtained for this concentration. If the 5 μg/ml concentration is disregarded, the result would be 15-26% for Fast Fraction (%), 48-87 s for Fast (s), t_{1/2} Fast (s), and 2400-4600 s for t_{1/2} Slow (s).

It is to be understood that the invention is not limited to the particular embodiments of the invention described above, but the scope of the invention will be established by the appended claims.

1. A method of characterizing a population of antibodies to an antigen, which comprises providing a sensor surface having the antigen immobilized thereto, contacting the sensor surface with a sample containing the antibody population to bind antibodies to the surface, detecting dissociation of antibodies from the sensor surface during a dissociation phase when sample no longer contacts the surface, wherein the dissociation behaviour of the antibody population is characterized by analyzing a first subpopulation and a second subpopulation of said antibody population, and wherein antibodies in said first subpopulation form a more stable complex with the immobilized antigen than antibodies in said second subpopulation.

2. The method of claim 1, further comprising fitting dissociation phase detection data to a kinetic model which describes simultaneous dissociation from two independent monovalent sites, one with a faster dissociation phase, and one with a slower dissociation phase.

3. The method of claim 2, wherein the kinetic model is a two-component equation:
R=R₁*e^{-k}^{_{d1}}^{(t-t}^{₀}⁾+R₂*e^{-k}^{_{d2}}^{(t-t}^{₀}⁾
where R is the detection response time at time t, R₁ and R₂ are the response contributions from the sites with the faster and slower dissociation phases, respectively, at the beginning of the dissociation at time t₀, and k_{d1} and k_{d2} are the dissociation rate constants for the sites with the faster and slower dissociation phases, respectively.

4. The method of claim 3, wherein the dissociation rate constants determined by the fitting are converted to half-lives (t_{1/2}) by the equation:
$${t}_{\frac{1}{2}} = \frac{ln 2}{{k}_{d}}$$
where t_{1/2} is the time required for the amount of antibody-antigen complex to be reduced to 50% during dissociation.

5. The method of claim 4, wherein the results of the fitting are presented by four parameters: fraction fast, t_{1/2} fast, fraction slow, t_{1/2} slow.

6. The method of claim 1, further comprising contacting the sample with sensor surfaces or discrete areas of a sensor surface having different domains of the antigen immobilized thereto.

7. The method of claim 1, further comprising contacting the sample with sensor surfaces or discrete areas of a sensor surface having different densities of immobilized antigen or antigen domains.

8. The method of claim 1, wherein the antigen is a drug.

9. The method of claim 1, wherein the antigen is a vaccine.

10. A method of determining the immunogenicity of drug, comprising monitoring the appearance of anti-drug antibodies in a patient over time by the method of claim 1, and determining any shift in proportions between more stable and less stable antibodies.
